(19) United States
(12) Patent Application Publication
(10) Pub. No.: US 2016/0098708 A1
(43) Pub. Date: Apr. 7, 2016

(54) SYSTEMS AND METHODS FOR PROCESSING TRANSACTIONS USING PAYMENT TOKENS

(71) Applicant: Capital One Financial Corporation, McLean, VA (US)

(72) Inventor: Daniel LOOMIS, San Francisco, CA (US)

(73) Assignee: CAPITAL ONE FINANCIAL CORPORATION, McLean, VA (US)

(21) Appl. No.: 14/504,113

(22) Filed: Oct. 1, 2014

(51) Int. Cl. G06Q 20/36; G06Q 20/32

(52) U.S. Cl. CPC G06Q 20/367; G06Q 20/32

(57) ABSTRACT

A computer system is enabled to process a transaction. The computer system receives a financial account holder identifier and a merchant identifier and generates a payment token uniquely associated with the financial account holder and merchant. The computer system communicates the payment token to a mobile payment device. The computer system can then receive a payment request that includes the payment token, a payee identifier, and a payor identifier associated with the payment request. The computer system can then authorize the payment request when the payee identifier matches the financial account holder identifier uniquely associated with the payment token and the payor identifier matches the merchant identifier uniquely associated with payment token.

### BACKGROUND

In a conventional credit card transaction, a credit card holder presents a financial account card, such as a credit card or debit card, to a merchant. The merchant typically swipes a magnetic stripe on the card through a card reader that is built into or attached to a point-of-sale (POS) terminal. The magnetic stripe generally includes account information, such as an account number of the card, an identity of the card holder, and an expiration date of the card. Once the merchant has swiped the card through the card reader, the account information is transmitted to the POS terminal. Alternatively, instead of the merchant swiping the card, the credit card holder may personally swipe the card at a self-service check out station or may insert the card into a card reader built into, for example, a gasoline pump. Once the card reader has read the card data, the card data is transmitted over a secure network, authenticated, and ultimately used to authorize a transaction. In any of these kinds of transactions, however, the credit card must be physically read by a magnetic stripe reader in order to obtain the card data that is stored on the magnetic stripe.

As the prevalence of wireless devices continues to increase, new methods of storing and transmitting data have begun to emerge. One such example is to use RFID (radio frequency identification) tags for transmitting information. RFID tags are microchips, some versions of which may store and encrypt data. Some wireless devices may also transmit information wirelessly using other technology such as Bluetooth, Wi-Fi, near field communication (NFC), and cellular technologies such as CDMA, TDMA, LTE, GSM, for example. In some cases a wireless device, such as cellular phone, tablet, or laptop, for example, can store and securely transmit card data using encryption techniques to a POS terminal. Another example of a wireless device that can store credit card data is a programmable credit card, a programmable computing device that can store one or more sets of credit card data selectable by the user for a transaction and capable of communicating wirelessly with other computers. Regardless of implementation, a wireless device storing credit card data may be used as a payment device without requiring the actual credit card to be swiped by a magnetic card reader. As most wireless devices have the capacity to store card data for more than one financial account card, they can act as an “electronic wallet” allowing a consumer to choose card data from one or more available financial cards to use in a transaction, similar to the consumer choosing a traditional, plastic credit card from her wallet. Unlike traditional credit cards that are limited in the data capacity by the amount of data that can be stored magnetically on the card, electronic wallets can have the ability to store more information beyond a sixteen digit account number, an expiration date, and identification information.

### SUMMARY

According to some disclosed embodiments, a method enables a computing device to process transactions. The method causes one or more processors to receive a financial account holder identifier and a merchant identifier, and the one or more processors generate a payment token uniquely associated with the financial account holder identifier and the merchant identifier. The method causes the one or more processors to communicate the payment token to a mobile payment device. The one or more processors then receives a payment request including the payment token, as well as a payee identifier and a payor identifier associated with the payment request. The one or more processors authorize the payment request when the payee identifier matches the financial account holder identifier uniquely associated with the payment token and the payor identifier matches the merchant identifier uniquely associated with payment token.

According to some disclosed embodiments, a computer system processes transactions. The computer system receives a financial account holder identifier and a merchant identifier and generates a payment token uniquely associated with them. The computer system communicates the payment token to a mobile payment device. The computer system can then receive a payment request including the payment token, as well as a payee identifier and a payor identifier associated with the payment request. The computer system can then authorize the payment request when the payee identifier matches the financial account holder identifier uniquely associated with the payment token and the payor identifier matches the merchant identifier uniquely associated with payment token.

According to some disclosed embodiments, a non-transitory computer readable medium stores instructions that cause one or more processors to process transactions. The instructions cause the one or more processors to receive a financial account holder identifier and a merchant identifier, and the one or more processors generate a payment token uniquely associated with the financial account holder identifier and the merchant identifier. The instructions further cause the one or more processors to communicate the payment token to a mobile payment device. The one or more processors then receives a payment request including the payment token, as well as a payee identifier and a payor identifier associated with the payment request. The instructions cause the one or more processors to authorize the payment request when the payee identifier matches the financial account holder identifier uniquely associated with the payment token and the payor identifier matches the merchant identifier uniquely associated with payment token.

It is to be understood that both the foregoing general description and the following detailed description are exemplary and explanatory only and are not restrictive.

### BRIEF DESCRIPTION OF THE DRAWINGS

The accompanying drawings, which are incorporated in and constitute a part of this specification, illustrate embodiments consistent with the disclosure. In the drawings:

FIG. 1 shows exemplary computing systems connected via a network that can be configured to perform the operations of disclosed embodiments;

FIG. 2 is an exemplary block diagram of the components of a wireless device;

FIG. 3 shows an exemplary wireless device including a card slot for inserting a financial account card;

FIG. 4 shows an example of a financial account card being inserted into the card slot of the wireless device shown in FIG. 3;

FIG. 5 is an exemplary block diagram of the components of the financial data system of FIG. 1;

FIG. 6 is an exemplary flow diagram of a process for generating and communicating a payment token.

FIG. 7 is an exemplary flow diagram of a process for processing a transaction.

### DESCRIPTION OF THE EMBODIMENTS

Unfortunately, financial accounts associated with financial account cards, such as credit cards and debit cards, are subject to fraud. One way to prevent or limit fraud is by using a tokenization scheme whereby payment tokens unique to a financial account and a merchant providing goods or services are required to authorize a transaction. For example, if Sally would like to use her debit card account at a local restaurant, a unique token associated only with Sally's debit card account and that local restaurant can be generated and used in each transaction between Sally and the restaurant. If the token is not present in a payment request, the request will be denied.

One problem with a tokenization scheme is the issuance and management of the tokens. One solution might be to issue a traditional financial account card to financial account card holders for use with a particular merchant. For example, Sally could be issued a card with number 1111 2222 3333 4444 that will only be accepted at the local restaurant, and when used will pay the local restaurant with funds from her debit card account. Such a solution, however, is impractical because traditional credit cards suffer from data capacity limitations restricting their storage to sixteen digits, which is inadequate to support the tokenization scheme. But, with the advent of electronic wallets, which have much larger capacity than traditional credit cards, a payment token scheme whereby financial account holders and merchants receive a unique payment token can be implemented.

Accordingly, the embodiments disclosed herein describe systems and methods supporting payment tokens in transactions. A financial data system can generate a payment token unique to a financial account holder and a merchant. When the financial account holder wishes to purchase goods or services from the merchant, the financial account holder can use their electronic wallet, typically a wireless device or programmable credit card, for the transaction. The electronic wallet, having larger capacity than a traditional credit card, can use the payment token in the transaction, and the financial data system can authorize the transaction using the payment token.

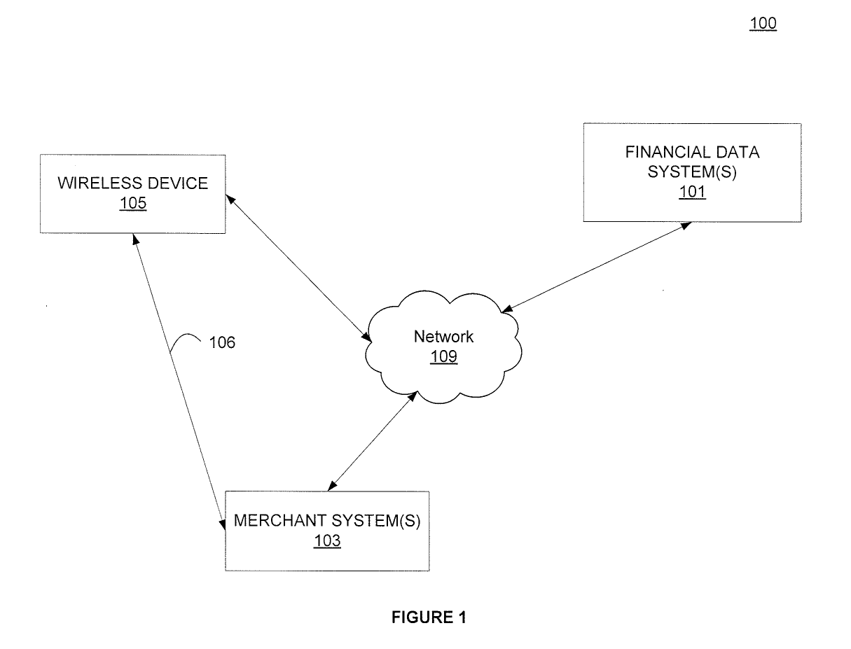

FIG. 1 shows a block diagram of an exemplary networked system 100 where a wireless device can communicate with one or more remote computing systems to perform operations consistent with the disclosed embodiments. In one embodiment, system 100 can include wireless device 105, one or more financial data system(s) 101, one or more merchant system(s) 103, and a network 109. The components and arrangement of the components included in system 100 can vary. Thus, system 100 can include fewer or additional components that perform or assist in the performance of one or more processes consistent with the disclosed embodiments.

In some embodiments, components of system 100 can include one or more computing devices (e.g., computer(s), server(s), etc.), memory storing data and/or software instructions (e.g., database(s), memory devices, etc.), and other known computing components. The one or more computing devices can be configured to execute software instructions stored on one or more memory devices to perform one or more operations consistent with the disclosed embodiments. Components of system 100 can be configured to communicate with one or more other components of system 100 via network 109, or directly with each other via direct communication means. For example, wireless device 105 can communicate with merchant system(s) 103 via direct communication link 106 which can include RFID, WiFi, Bluetooth, LiFi, or any other wireless communication protocol known in the art.

Financial data system(s) 101 can be a system or systems associated with financial service providers. Financial services providers can be a business entity that provides financial account products to consumers such as a bank, credit card issuer, or other entity that generates, provides, manages, and/or maintains financial service accounts for one or more users. Financial data system(s) 101 can generate, maintain, store, provide, and/or process financial data associated with one or more financial account products, such as financial cards. Financial data can include information about financial accounts including, but not limited to, issuing financial institution, card holder name, card holder address, account balance, available credit, existing fees, card expiration dates, and account transaction data (e.g., transaction dates, transaction amounts, transaction types, location of transaction, etc.).

In some embodiments, financial data system(s) 101 can provide account information to requesting computing systems, such as wireless device 105, for example. Financial data system(s) 101 can make accessible, in some embodiments, an application programming interface (API) that provides one or more methods for obtaining account information to requesting computing systems. For example, a requesting computing system (such as wireless device 105) can provide financial data system(s) 101 with an financial card account number via the API, and financial data system(s) 101 can provide the requesting computing system with the name, address, expiration date, issuing bank, or other information associated with the financial card account number. The account information can be provided as a binary data stream, serialized data object, XML object, or in some other data form known to those with skill in the art.

According to some embodiments, financial data system(s) 101 can generate payment tokens that are associated with a financial card account holder and a particular merchant. For example, financial data system(s) 101 can generate the payment token using payment token generation process 600 described below. Financial data system(s) 101 can make an API accessible that accepts a financial account holder identifier (such as financial account card number, mobile phone number, a name, address, a Social Security Number, any combination of these identifiers or some other identifier that is capable of identifying a financial account) and a merchant identifier (such as employer identification number (EIN), business name, address, telephone number, any combination of these identifiers or some other identifier that is capable of identifying a merchant) and return a payment token.

Merchant system(s) 103 can be one or more computing devices configured to perform one or more operations consistent with disclosed embodiments. Merchant system(s) 103 can be a computing device that is controlled and operated by a merchant that provides products (e.g., goods and/or services), such as a restaurant (e.g., Outback Steakhouse®, Burger King®, etc.), retailer (e.g., Amazon.com®, Target®, etc.), grocery store, service provider (e.g., utility company, insurance company, financial service provider, automobile repair services, etc.), non-profit organization (e.g., ACLU™, AARP®, etc.) or any other type of entity that provides goods, services, and/or information that consumers (i.e., end-users or other business entities) can purchase, consume, use, etc. For ease of discussion, the present disclosure may describe exemplary embodiments in the context of purchase transactions involving goods from retail merchants, but merchant system(s) 103 is not limited to systems associated with retail merchants that conduct business in any particular industry or field. According to some embodiments, merchant system(s) 103 can be a mobile device (e.g., tablet, smart phone, etc.), a desktop computer, a laptop, a server or any other type of computing device. Merchant system(s) 103 can also include a television, e-reader, or any other type of device capable of communicating with other components of system 100.

Merchant system(s) 103 can include a POS terminal, which can be a dedicated POS terminal, or a software application that can configure a computing device to accept financial account card payments. For example, the payment application can configure the computing device to interface with an input device connected to the computing system. The input device can include a terminal or port that accepts data financial account card data from wireless device 105.

According to some embodiments, merchant system(s) 103 may be configured with a transceiver to transmit transaction data pertaining to the transaction. The transaction data can be transmitted to wireless device 105, or any other computing device configured to receive transaction data. For example, the POS terminal, or some other part of merchant system(s) 103 may transmit a merchant identifier corresponding to the merchant, or information regarding the transaction, such as the transaction amount or the items that are the subject of the transaction to the wireless device.

In some embodiments, system 100 includes wireless device 105. In some embodiments, wireless device 105 can include a mobile phone, a personal digital assistant, a tablet computing device, a laptop computing device, or the like. Additionally or alternatively, wireless device 105 can be an embedded system or other dedicated computing hardware device configured to perform operations consistent with disclosed embodiments. In some embodiments, wireless device 105 can be a programmable financial account card. For example, wireless device 105 may be a programmable financial account card configured to interface with existing POS systems and configured to store and provide financial card account card data for one or more financial account cards of a consumers. In some embodiments, a programmable financial account card can take the approximate size and shape of a traditional, plastic, financial account card.

System 100 can also include network 109 in some embodiments, which can be any type of network configured to provide communications between components of system 100. For example, network 109 can be any type of network (including infrastructure) that provides communications, exchanges information, and/or facilitates the exchange of information, such as the Internet, a Local Area Network, or other suitable connection(s) that enables the sending and receiving of information between the components of system 100. In other embodiments, one or more components of system 100 can communicate directly through dedicated communication link(s), such as link 106.

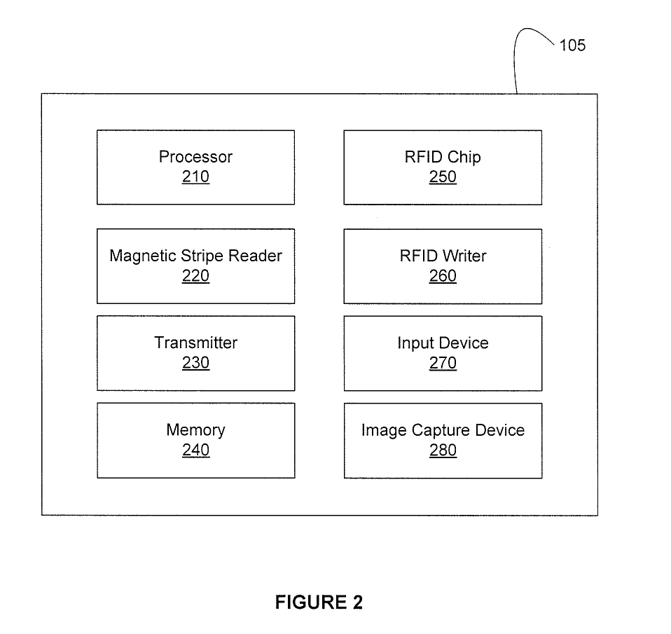

FIG. 2 shows a block diagram of exemplary components of wireless device 105 according to one embodiment. For example, wireless device 105 may include a processor 210, a magnetic stripe reader 220, a transmitter 230, a memory 240, an RFID chip 250, an RFID writer 260, an input device 270, and an image capture device 280. Other components that may be included in wireless device 105 include a battery (not shown) for supplying power to transmitter 230 and RFID chip 250. Furthermore, wireless device 105 may include a sensor (not shown) for detecting the presence of a card. Still further, wireless device 105 may include a smart card reader (not shown) in addition to, or in place of, magnetic stripe reader 220. Wireless device 105 may also include a display, and in some cases a touch sensitive display. Any of the components illustrated in FIG. 2 can be a peripheral that interfaces with the wireless device. For example, in some embodiment, magnetic stripe reader 220 can be a peripheral device that interfaces with wireless device 105.

In some embodiments, processor 210 may instruct magnetic stripe reader 220 to read card data from a card as it is inserted into wireless device 105. Alternatively, a smart card reader included in wireless device 105 may read data from the card. Further, card data that has been read from a card may be stored in memory 240 or may be written by RFID writer 260 to RFID chip 250. Transmitter 230 may be used in addition to RFID chip 250 to transmit card data and/or other data from wireless device 105. For example, transmitter 230 may be used to boost the signal strength of radio frequency signals sent from wireless device 105.

In some embodiments, card data from a card can be input to wireless device 105 using input device 270. For example, input device 270 can include a keypad or touchscreen configured to receive input from a user, and processor 210 may interpret data received by the input device 270 as card data which is stored in memory 240 or RFID chip 250. Wireless device may also capture card data from a card using image capture device 280, which can include a camera, optical sensor, infrared sensor, and/or other sensors configured to capture an image. Once an image of a card is captured by image capture device 280, processor 210 can store the card data in memory or write it to RFID Chip 250 using RFID writer 260.

In some embodiments, wireless device 105 can be used to purchase goods or services in a wireless transaction. During a transaction, a user may make a secured payment with wireless device 105. In such a transaction, card data stored on wireless device 105 may be transmitted by, for example, RFID chip 250 to a nearby RFID reader associated with a merchant, such as merchant system(s) 103. As wireless device 105 may be capable of storing card data for one or more financial account cards, wireless device 105 can also act as an electronic wallet.

A user of wireless device 105 may also store data for multiple cards by providing a first card to wireless device 105 so that the device may store the card data from the first card in memory 240. The user may then provide a second card to wireless device 105 which is also stored in memory 240. After a user has stored card data for more than one card in wireless device 105, the user may select a card from a menu screen shown on a display of wireless device 105. In some embodiments, wireless device 105 may suggest a stored card or default the selection of the card on displayed menu based on user preferences, data describing the transaction for which the card will be used, or based on an offer associated with the purchase (e.g., a coupon for the product or service being purchased, lower Annual Percentage Rate (APR), increased loyalty program rewards points, etc.) presented by wireless device 105, consistent with embodiment disclosed herein.

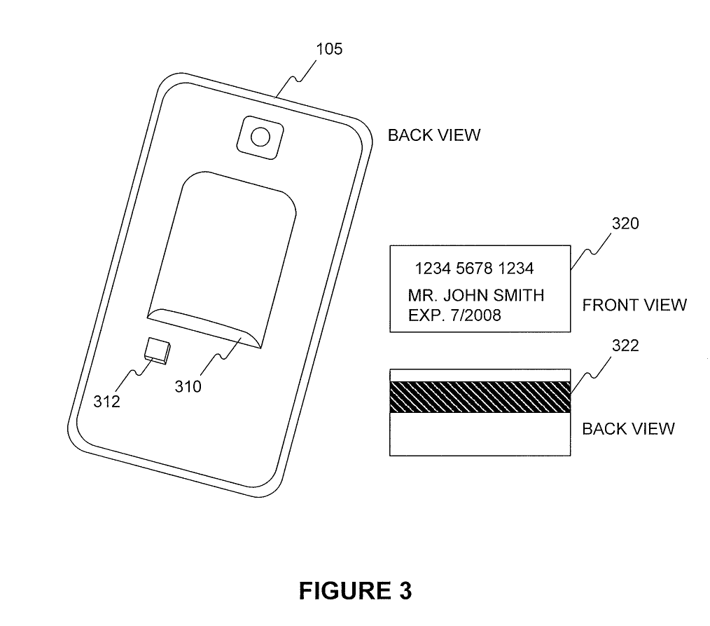

In some embodiments, wireless device 105 may receive the card data through a dedicated card reader attached to, or part of, wireless device 105 as shown in FIG. 3. FIG. 3 shows a back view of an embodiment of wireless device 105 including a card slot 310 for inserting a card 320 and an eject button 312. According to the example shown in FIG. 3, wireless device 105 is preferably a mobile phone. Wireless device 105, however, may be a PDA or other handheld device. Although wireless device 105 shows card slot 310 on the back of the device, card slot 310 may be incorporated into any appropriate location of wireless device 105. Further, card slot 310 may be oriented in any appropriate direction for receiving card 320. In some embodiments, card slot 310 may comprise an attachment to wireless device 105, such as a card swipe attachment (e.g., Capital One™ Spark Pay, Flagship ROAMpay™, Intuit® GoPayment, etc.). In exemplary embodiments, card slot 310 may include a reader (not shown) for reading card data on card 320. Further, in some embodiments, wireless device 105 may not include card slot 310 and instead can receive card data via input devices such as a touchscreen, keypad, or camera. For example, a user of wireless device 105 may manually enter an account number associated with the financial card, or the user may take a picture of the card with wireless device's 105 camera, and OCR capable software installed on wireless device 105 may extract the card data.

Card 320 may be a financial account card, such as a credit card, a debit card, a smart card, an ATM card, or any other card associated with a financial account and that may be used to make purchase transactions. Card 320 includes, for example, account information such as information identifying the card holder, an account number, and expiration date. Further, as shown in FIG. 3, according to the back view of card 320, card 320 includes magnetic stripe 322. In the case of a smart card, card 320 will include a smart card chip (not shown), which may be read by a smart card reader included in wireless device 105 in addition to, or instead of, a reader to read magnetic stripe 322.

According to some embodiments, once card 320 is inserted into wireless device 105, a mechanism (not shown) may hold card 320 in place such that it does not fall out of wireless device 105. Furthermore, wireless device 105 may include eject button 308 for removing card 320 from wireless device 105. For example, when a user desires to remove card 320 from wireless device 105, the user may press eject button 308, which ejects card 320 through card slot 310.

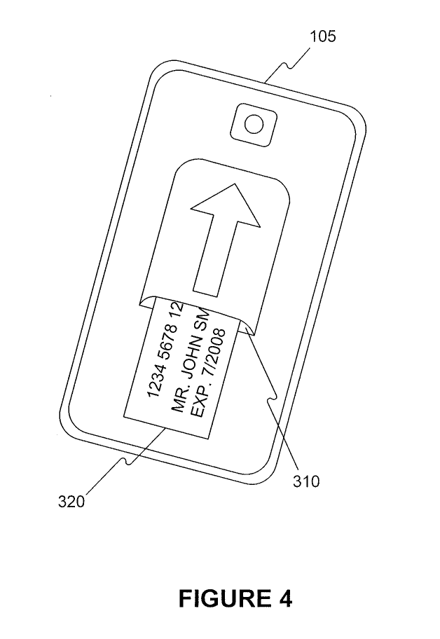

FIG. 4 shows card 320 being inserted into card slot 310 of wireless device 105. When card 320 is inserted into card slot 310 of wireless device 105, a magnetic stripe reader (not shown) may read card data stored on magnetic stripe 322. Alternatively, card 320 may include a smart card chip, which may be reader by a smart card reader (not shown) included in wireless device 105. Card data may be stored in a memory of wireless device 105 (e.g., memory 240) or may be used to program an RFID chip included in wireless device 105 (e.g. RFID Chip 250).

In some embodiments, the wireless device may communicate with one or more remote computer systems to obtain additional card data that is not stored directly on a financial account card. For example, the wireless device may communicate with one or more remote computer systems to obtain the identity of the financial institution that issued the financial account card, branding associated with the card, the name and address of the account holder of financial account card, etc.

Wireless device 105 may also include security features that may be employed by wireless device 105 to authorize a transaction. For example, a security validation may be required for transactions to prevent unauthorized use of card data stored in memory 240. Further, card data may be encrypted using encryption techniques so that transmitted card data cannot be intercepted in an accessible form.

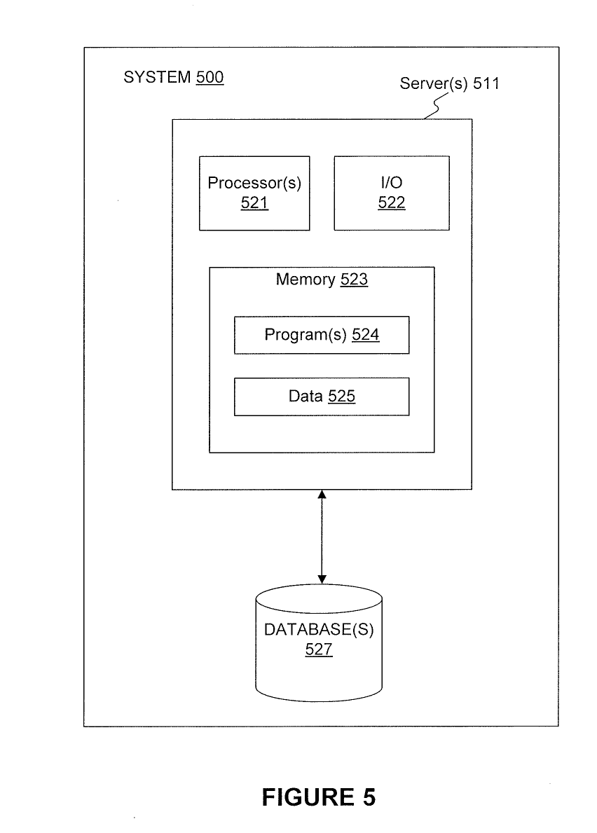

FIG. 5 shows an exemplary system 500 for implementing certain embodiments consistent with the present disclosure. For example, system 500 may represent components included with financial data system(s) 101 and/or merchant system(s) 103. For instance, financial data system(s) 101 may be configured with a computer system similar to system 500. Also, for example, merchant system(s) 103 may be configured with a computer system similar to system 500.

In one embodiment, system 500 may include a computing device (shown as an example server 511) having one or more processors 521, one or more memories 523, and one or more input/output (I/O) devices 522. In some embodiments, server 511 may take the form of a mobile computing device, general purpose computer, a mainframe computer, or any combination of these components. Alternatively, server 511 (or a system including server 511) may be configured as a particular apparatus, embedded system, dedicated circuit, and the like based on the storage, execution, and/or implementation of the software instructions that perform one or more operations consistent with the disclosed embodiments. According to some embodiments, server 511 may comprise web server(s) or similar computing devices that generate, maintain, and provide web site(s) consistent with disclosed embodiments. Server 511 may be standalone, or it may be part of a subsystem, which may be part of a larger system. For example, server 511 may represent distributed servers that are remotely located and communicate over a network (e.g., network 190) or a dedicated network, such as a LAN.

Processor 521 may include one or more known processing devices, such as a microprocessor from the Pentium™ or Xeon™ family manufactured by Intel™, the Turion™ family manufactured by AMD™, or any of various processors manufactured by Sun Microsystems. The disclosed embodiments are not limited to any type of processor(s) configured in server 511.

Memory 523 may include one or more storage devices configured to store instructions used by processor 521 to perform one or more operations consistent with the disclosed embodiments. For example, memory 523 may be configured with one or more software instructions, such as program(s) 524 that may perform one or more operations when executed by processor 521. The disclosed embodiments are not limited to separate programs or computers configured to perform dedicated tasks. For example, memory 523 may include a single program 524 that performs the functions of the server 511, or program 524 could comprise multiple programs. Additionally, processor 521 may execute one or more programs located remotely from server 511. For example, financial data system(s) 101 and/or merchant system(s) 103 may, via server 511, access one or more remote programs that, when executed, perform functions related to certain disclosed embodiments. Memory 523 may also store data 525 that may reflect any type of information in any format that the system may use to perform operations consistent with the disclosed embodiments.

I/O devices 522 may be one or more devices configured to allow data to be received and/or transmitted by server 511. I/O devices 522 may include one or more digital and/or analog communication devices that allow server 511 to communicate with other machines and devices, such as other components of systems 100.

Server 511 may also be communicatively connected to one or more database(s) 527. Server 511 may be communicatively connected to database(s) 527 through network 109. Database 527 may include one or more memory devices that store information and are accessed and/or managed through server 511. By way of example, database(s) 527 may include Oracle™ databases, Sybase™ databases, or other relational databases or non-relational databases, such as Hadoop sequence files, HBase, or Cassandra. The databases or other files may include, for example, data and information related to the source and destination of a network request, the data contained in the request, etc. Systems and methods of disclosed embodiments, however, are not limited to separate databases. In one aspect, system 500 may include database 527. Alternatively, database 527 may be located remotely from the system 500. Database 527 may include computing components (e.g., database management system, database server, etc.) configured to receive and process requests for data stored in memory devices of database(s) 527 and to provide data from database 527.

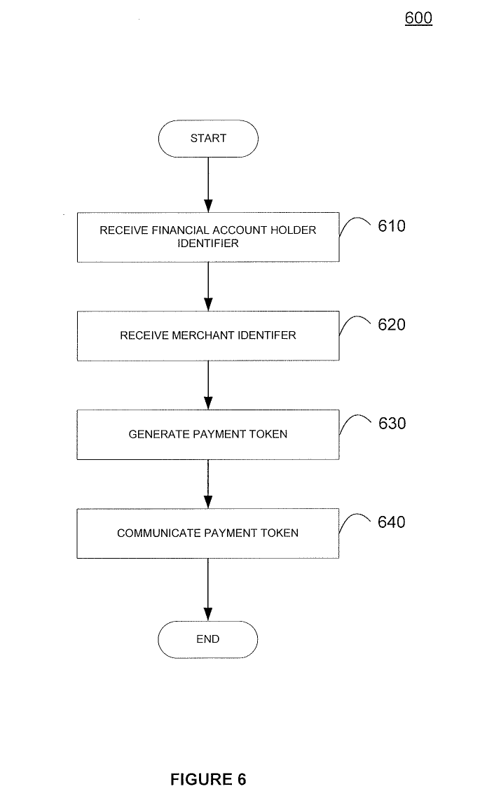

FIG. 6 shows a flowchart of an exemplary payment token generation process 600 consistent with disclosed embodiments. According to some embodiments, one or more sub-processes of process 600 can be performed by financial data system(s) 101, or some other computing system associated with financial data system(s) 101, by executing software instructions stored in one or more memory devices. Payment token generation process 600 can be executed by a financial data system(s) 101 to provide a payment token to wireless device 105 and/or merchant system(s) 103 that can be used by them during transactions.

Payment token generation process 600 begins when the financial data system receives a financial account holder identifier (step 610). The financial account holder identifier can be, in some embodiments, any identifier that can uniquely identify a financial account holder or financial card account. For example, the financial account holder identifier can be a sixteen digital financial account card number that is typically provided to consumers via a financial account card such as a credit card or a debit card. The financial account holder identifier can also include a mobile telephone number associated with a financial account holder or a government issued identification number such as social security number, employment identification number, driver's license number, or any other number that can be used to uniquely identifier a consumer. The financial account holder identifier can also relate to financial account holder's wireless device 105. For example, the financial account holder identifier might include the device identifier of wireless device 105, or the device identifier of wireless device 105 and a personal identification number. In some embodiments, the financial account holder identifier can be some combination of any of the above listed identifiers.

Payment token generation process 600 can continue when the financial data system receives a merchant identifier (step 620). The merchant identifier can be, in some embodiments, any identifier that uniquely identify a merchant. For example, the merchant identifier can include the merchant's employment identification number, a financial card account number associated with the merchant, the merchant's name, the merchant's address, any combination of the above mentioned identifiers, or any other identifier that could be used to uniquely identify a merchant. In some embodiments, an identifier associated with the merchant computing system of the merchant such as a device identifier of the merchant's POS terminal, or application serial number of a POS application executing on a merchant computing system can be used as a merchant identifier.

In some embodiments, the financial data system receives the financial account holder identifier and the merchant identifier (steps 610, 620) in a pre-registration process. For example, the financial data system may host a web site or other user interface where consumers can register for payment tokens that can be used with a particular merchant. In some embodiments, the financial data system receives the financial account holder identifier and the merchant identifier (steps 610 and 620) during the first transaction between the financial account holder and the merchant. In such embodiments, enrollment may take place without the consumer's knowledge and, from the consumer's perspective, it may appear that the consumer is using her wireless device 105 as an electronic wallet that is not configured to use unique consumer-merchant payment tokens for transactions.

Once the financial data system receives the financial account holder identifier and the merchant identifier, the financial data system can generate the payment token (step 630). In some embodiments, the payment token can be encrypted using a known or proprietary encryption technique. The payment token can take on a format that is similar to a financial account card number, for example, it may be a sixteen digit number. In some embodiments, the payment token can be a data structure, serialized object, XML file, data file, binary data stream, or any other set of data known in the art. In some embodiments, the payment token is generated using operations that will ensure the same output for any two given inputs. For example, the operations will ensure that identical payment tokens will be generated when the same financial account holder identifier and merchant identifier are provided to payment token generation process 600.

After payment token generation process 600 generates the payment token, it can communicate the token to the financial account holder's wireless device 105, merchant computing system(s) 103, or both (step 640). In some embodiments, wireless device 105 stores a copy of the payment token to use in later transactions with the merchant. In some embodiments, merchant computing system(s) 103 stores the payment token for later use in transactions with the financial account holder or the financial account holder's wireless device 105.

In some embodiments, payment token generation process 600 can include additional information associated with the financial account holder and the merchant that can limit the types of transactions that may be authorized using the generated payment token. According to some embodiments, the payment token can contain a transaction amount limit, which can be lower than the spending limit associated with the financial account for which the payment token was generated. For example, a payment token may be generated for use in a coffee shop. The financial account can have a $10,000 spending limit, but the typical transaction at the coffee shop may be no more than $10, and the coffee shop may sell no item over $100. When generating the payment token, payment token generation process 600 can include a spending limit so that the payment token for using the financial account at the coffee shop is only authorized for transactions lower than $125.

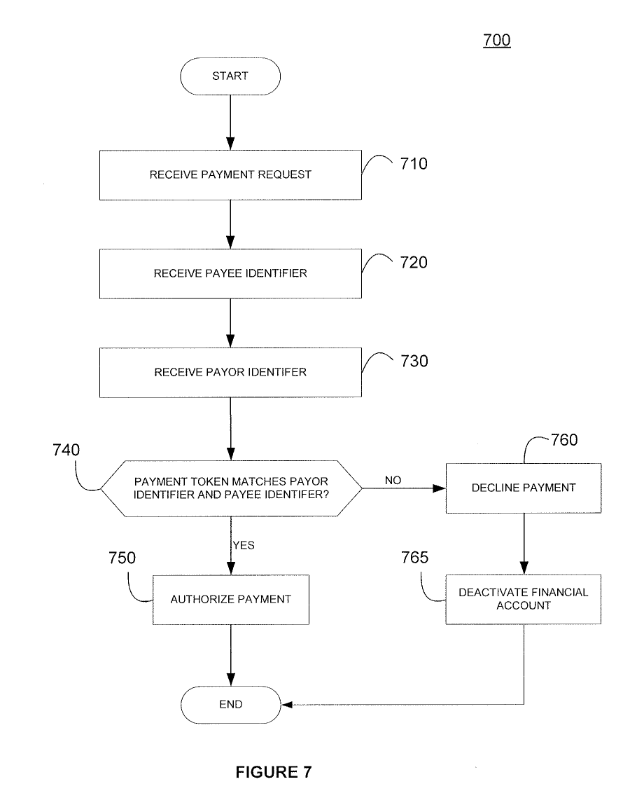

FIG. 7 shows a flowchart of an exemplary transaction processing process 700 consistent with disclosed embodiments. According to some embodiments, one or more sub-processes of process 700 can be performed by financial data system(s) 101, or some other computing system associated with financial data system(s) 101, by executing software instructions stored in one or more memory devices. In some embodiments, transaction processing process 500 can be executed by a financial data system(s) 101 to process transactions using payment tokens that payment token generation process 600 generated.

Transaction processing process 700 begins when the financial data system receives a payment request (step 710). In some embodiments, the payment request can include a transaction amount and/or line-item data concerning the transaction. In some embodiments, the payment request can also include a payee identifier (step 720) and a payor identifier (step 730). The payee identifier can be an identifier associated with a financial card account, such as a financial card account number, or the entity making payment in the transaction. For example, the payee identifier can be of the same format as the financial account holder identifier discussed above with respect to FIG. 6. The payor identifier can be any identifier associated with an entity that is accepting payment in the transaction. For example, the payor identifier can be of the same format as the merchant identifier discussed above with respect to FIG. 6.

In some embodiments, the payment request can also include a payment token. The payment token can be a payment token that was generated using payment token generation process 600. In some embodiments, the payment token is stored on a wireless device associated with the payee. When the payee initiates a transaction using a financial account card stored on a her wireless device, the wireless device may receive a payor identifier from the payor's merchant computing system. The wireless device may then determine if it has a payment token associated with the payor identifier, and if so, communicate the payment token either to the payor's merchant computing device or the financial data system associated with the payee's financial card account for use in the transaction. The payment token can then be associated with the payment request by including the payment token with the payment request, or through the use of an identifier linking the payment request to the payment token.

Once transaction processing process 700 receives the payment request (step 710), the payee identifier (720), and the payor identifier (730), it can determine if the payee identifier and the payor identifier match the payment token associated with the request (step 740). In some embodiments, the financial data system can determine a match by generating a temporary payment token using the payee identifier and the payor identifier as input to payment token generation process 600 and compare the temporary payment token to the payment token received as part of the payment request. In some embodiments, the financial data system can decrypt the payment token it receives in the request, extract the financial account holder identifier and merchant identifier from the request, and compare them to the payee identifier and the payor identifier.

When there is a match (step 740: YES), the financial data system authorizes the transaction and process payment using known techniques (step 750). If the received payee identifier and payor identifier do not match the payment token associated with the request (step 740: NO), then the payment is declined (step 760). When payment is declined, the financial data system may communicate a message to the payee's wireless device and/or payor's merchant computing system notifying them of the declined payment. In some embodiments, the financial account associated with the payment request (e.g., the financial account associated with the financial card account number that is the payee identifier in some instances) can be deactivated as a security measure (step 765).

The foregoing descriptions have been presented for purposes of illustration and description. They are not exhaustive and do not limit the invention to the precise form disclosed. Modifications and variations are possible in light of the above teachings or may be acquired from practicing of the invention. For example, the described implementation includes software but the present invention may be implemented as a combination of hardware and software or in hardware alone.

Additionally, although aspects of the present invention are described as being stored in memory, one skilled in the art will appreciate that these aspects can also be stored on other types of computer-readable media, such as secondary storage devices, like hard disks, floppy disks, or CD-ROM; a carrier wave from the Internet or other propagation medium; or other forms of RAM or ROM. The scope of the invention is defined by the claims and their equivalents.

Other embodiments of the invention will be apparent to those skilled in the art from consideration of the specification and practice of the invention disclosed herein. The specification and examples should be considered as exemplary only, with a true scope and spirit of the invention being indicated by the following claims.

What is claimed is:

1. A method for processing transactions comprising:
receiving, by one or more processors, a financial account holder identifier and a merchant identifier;
generating, by the one or more processors, a payment token uniquely associated with the financial account holder identifier and the merchant identifier;
communicating the payment token to a mobile payment device;
receiving a payment request including the payment token;
receiving a payee identifier and a payor identifier associated with the payment request; and
authorizing, by the one or more processors, the payment request when the payee identifier matches the financial account holder identifier uniquely associated with the payment token and the payor identifier matches the merchant identifier uniquely associated with payment token.

2. The method of claim 1 further comprising:
communicating a decline message when the payee identifier does not match the financial account holder identifier uniquely associated with the payment token.

3. The method of claim 1 further comprising:
communicating a decline message when the payor identifier does not match the merchant identifier uniquely associated with payment token.

4. The method of claim 1 further comprising:
deactivating a financial account associated with the financial account identifier when the payee identifier does not match the financial account holder identifier uniquely associated with the payment token.

5. The method of claim 1 further comprising:
deactivating a financial account associated with the financial account identifier when the payor identifier does not match the merchant identifier uniquely associated with payment token.

6. The method of claim 1 wherein the mobile payment device is a wireless computing device.

7. The method of claim 1 wherein the mobile payment device is a programmable financial account card.

8. A system for processing transactions comprising:
one or more processors; and
a memory having instructions that when executed by the one or more processors, cause the one or more processors to perform the operations of:
receiving a financial account holder identifier and a merchant identifier;
generating a payment token uniquely associated with the financial account holder identifier and the merchant identifier;
communicating the payment token to a mobile payment device;
receiving a payment request including the payment token;
receiving a payee identifier and a payor identifier associated with the payment request; and
authorizing the payment request when the payee identifier matches the financial account holder identifier uniquely associated with the payment token and the payor identifier matches the merchant identifier uniquely associated with payment token.

9. The system of claim 8 wherein the instructions further cause the one or more processors to perform the operation of:
communicating a decline message when the payee identifier does not match the financial account holder identifier uniquely associated with the payment token.

10. The system of claim 8 wherein the instructions further cause the one or more processors to perform the operation of:
communicating a decline message when the payor identifier does not match the merchant identifier uniquely associated with payment token.

11. The system of claim 8 wherein the instructions further cause the one or more processors to perform the operation of:
deactivating a financial account associated with the financial account identifier when the payee identifier does not match the financial account holder identifier uniquely associated with the payment token.

12. The system of claim 8 wherein the instructions further cause the one or more processors to perform the operation of:
deactivating a financial account associated with the financial account identifier when the payor identifier does not match the merchant identifier uniquely associated with payment token.

13. The system of claim 8 wherein the mobile payment device is a wireless computing device.

14. The system of claim 8 wherein the mobile payment device is a programmable financial account card.

15. A non-transitory computer readable medium storing instructions that, when executed by one or more processors, causes the one or more processors to perform operations comprising:
receiving a financial account holder identifier and a merchant identifier;
generating a payment token uniquely associated with the financial account holder identifier and the merchant identifier;
communicating the payment token to a mobile payment device;
receiving a payment request including the payment token;
receiving a payee identifier and a payor identifier associated with the payment request; and
authorizing the payment request when the payee identifier matches the financial account holder identifier uniquely associated with the payment token and the payor identifier matches the merchant identifier uniquely associated with payment token.

16. The non-transitory computer readable medium of claim 15, wherein the operations further comprise:
communicating a decline message when the payee identifier does not match the financial account holder identifier uniquely associated with the payment token.

17. The non-transitory computer readable medium of claim 15, wherein the operations further comprise:
communicating a decline message when the payor identifier does not match the merchant identifier uniquely associated with payment token.

18. The non-transitory computer readable medium of claim 15, wherein the operations further comprise:
deactivating a financial account associated with the financial account identifier when the payee identifier does not match the financial account holder identifier uniquely associated with the payment token.

19. The non-transitory computer readable medium of claim 15, wherein the operations further comprise:
deactivating a financial account associated with the financial account identifier when the payor identifier does not match the merchant identifier uniquely associated with payment token.

20. The system of claim 8 wherein the mobile payment device is a wireless computing device.
